(19) United States
(12) Patent Application Publication
(10) Pub. No.: US 2002/0035462 A1
(43) Pub. Date: Mar. 21, 2002

(54) Method of and device for simulation

(76) Inventors: Makoto Kidera, Tokyo (JP); Motoaki Tanizawa, Tokyo (JP)

Correspondence Address: OBLON, SPIVAK, McCLELLAND MAIER & NEUSTADT, P.C., Fourth Floor 1755 Jefferson Davis Highway, Arlington, VA, 22202, US

(21) Appl. No.: 09/740,901

(22) Filed: Dec. 21, 2000

(30) Foreign Application Priority Data
Jul. 24, 2000 (JP) P2000-222025

(51) Int. Cl. G06F 17/50

(52) U.S. Cl. 703/14

(57) ABSTRACT

A method of and device for simulation which represents variations in electrical characteristics (Idsat, Vth and the like) of a device constituting a semiconductor integrated circuit in the form of a corner model including corners defining the limits of the variations is provided. A circuit simulation is performed to determine device parameter sensitivities which are the derivatives of the electrical characteristics with respect to device parameters such as ΔL, ΔW, Tox and Vth0. Variations in the device parameters at each corner are determined by applying the device parameter sensitivities and the values of the electrical characteristics required for each corner to the normal equation of the linear least squares method. The method and device can determine the values of a set of device parameters at each corner without the need to repeat the circuit simulation and can uniquely determine the values of the set of device parameters.

### BACKGROUND OF THE INVENTION

1. Field of the Invention

The present invention relates to a method of and device for simulation which generates models that reflect statistical variations (the amount of change) in electrical characteristics of a device for determination of margins in circuit design.

2. Description of the Background Art

In recent years, the size reduction of devices has been rapidly promoted, and the degree of integration of semiconductor integrated circuits has accordingly been dramatically on the increase. At the present time, simulation devices such as SPICE (Simulation Program with Integrated Circuit Emphasis) are used to assist in designing semiconductor integrated circuits having such an increased degree of integration.

Conventionally, there are variations in statistics on values (referred to hereinafter as “model parameters”) regarding the shape of devices in manufactured semiconductor integrated circuits and parameters (referred to hereinafter as “process parameters”; the model parameters and the process parameters are together referred to as “device parameters”) regarding manufacturing conditions during manufacturing steps such as the concentration of impurity for implantation into semiconductor substrates. Such variations in model parameters and process parameters give rise to variations in electrical characteristics of the devices during operation. With MISFETs (Metal Insulator Semiconductor Field Effect Transistors) as an example, variations in model parameters such as a gate length and a gate insulation film thickness give rise to variations in threshold voltage value and in saturation current value in constant current regions.

As the device size reduction is promoted, the variations in model parameters and process parameters are not necessarily scaled down (or reduced) in a similar manner. Thus, the influence of the variations in these parameters upon the variations in electrical characteristics is becoming non-negligible.

In circuit design with suitable margins, it is therefore important to cause a simulation device to reflect the variations in model parameters and process parameters and the influence thereof upon the variations in electrical characteristics of the devices. Although various methods of such reflection have been attempted, attention will now be directed to a method which uses a model generally known as a “corner model.”

The corner model refers to a model wherein some of the varying electrical characteristics of a device which show a lower frequency of occurrence than statistical typical values (average values, median values and the like) are expressed as corners which define the limits of the variations. At the corners, to what extent the variations in model parameters and process parameters are tolerated is calculated. This corner model will be described, taking a CMOS (Complementary Metal Oxide Semiconductor) inverter as an example.

Examples of the model parameters used herein include a channel length difference ΔL between the geometric gate length and the effective channel length of NMOS and PMOS transistors constituting the CMOS inverter, a channel width difference ΔW between the geometric gate width and the effective channel width of the transistors, and a gate insulation film thickness Tox. The geometric gate length and the geometric gate width refer to the gate length L_{M} and the gate width W_{M}, respectively, of a gate electrode 5 as viewed in outside configuration in a MISFET structure shown in cross-section of FIG. 7 and in top plan of FIG. 8. The effective channel length and the effective channel width refer to the effective length and width, respectively, of a channel formed in a channel region 11 between source/drain structures 2 and 3.

An example of the process parameters used herein includes a threshold voltage Vth0 at the time that a body voltage is 0 V, the threshold voltage Vth0 being determined by an impurity concentration and the like. Examples of the electrical characteristics of a device used herein include a saturation current value Idsat in a constant current region and a threshold voltage value Vth.

It is assumed that the CMOS inverter has the highest response speed in a condition A and has the lowest response speed in a condition B. Considering the NMOS and PMOS transistors as a pair, there are four possible conditions: a condition AA wherein both the NMOS and PMOS transistors are in the condition A; a condition BB wherein both the NMOS and PMOS transistors are in the condition B; a condition AB wherein the NMOS and PMOS transistors are in the conditions A and B, respectively; and a condition BA wherein the NMOS and PMOS transistors are in the conditions B and A, respectively.

FIG. 9 is a graph showing an NMOS saturation current value Idsatn on the horizontal axis versus a PMOS saturation current value Idsatp on the vertical axis. In the graph of FIG. 9, the point of intersection of the line indicating a typical value Itypn of the NMOS saturation current value and the line indicating a typical value Itypp of the PMOS saturation current value is defined as a point P0a. Then, variations in saturation current value in the constant current region can be expressed, for example, as a quadrilateral SQa surrounding the point P0a and having four points P1a to P4a at the corners. The area of the quadrilateral SQa and the position thereof relative to the point P0a which fall within a desired range provide semiconductor integrated circuits having desired electrical characteristics, to increase the yield of the semiconductor integrated circuits.

Of the four points at the corners of the quadrilateral SQa, the point P1a has an NMOS saturation current value greater than the typical value Itypn of the NMOS saturation current by δIdsatna, and a PMOS saturation current value greater than the typical value Itypp of the PMOS saturation current by δIdsatpa. The point P3a has an NMOS saturation current value less than the typical value Itypn by δIdsatnb, and a PMOS saturation current value less than the typical value Itypp by δIdsatpb. The greater the saturation current value is, the higher the response speed of the NMOS and PMOS transistors is. Therefore, the point P1a at which both of the saturation current values Idsatn and Idsatp are maximized corresponds to the condition AA, and the point P3a at which both are minimized corresponds to the condition BB.

In the light of the steps of forming the CMOS inverter, it is difficult to imagine the occurrence of a combination of an NMOS saturation current value greater than the typical value Itypn by δIdsatna and a PMOS saturation current value less than the typical value Itypp by δIdsatpb. Therefore, the point P4a having a smaller difference in characteristic value between the NMOS and PMOS transistors than a point P5a indicating the above-mentioned combination corresponds to the condition AB. Similarly, the point P2a having a smaller difference in characteristic value between the NMOS and PMOS transistors than a point P6a corresponds to the condition BA.

The determination of a set of variations from the device parameter values of a device corresponding to the point P0a (i.e., a set of differences δ(ΔL), δ(ΔW), δTox and δVth0 between the device parameters values at the point P0a and the device parameter values at each of the corner points; which are referred to hereinafter as a device parameter set) at each of the corner points provides the range of the variations in the device parameters corresponding to the quadrilateral SQa indicating the entire area of the variations in the saturation current values Idsatn and Idsatp.

FIG. 10 is a graph showing the absolute value Vthn of an NMOS threshold voltage on the horizontal axis versus the absolute value Vthp of a PMOS threshold voltage on the vertical axis. In the graph of FIG. 10, the point of intersection of the line indicating a typical value Vtypn of the absolute value of the NMOS threshold voltage and the line indicating a typical value Vtypp of the absolute value of the PMOS threshold voltage is defined as a point P0b. Then, variations in threshold voltage can be expressed as a quadrilateral SQb surrounding the point P0b and having four points P1b to P4b at the corners, in a manner similar to the quadrilateral SQa.

Of the four points at the corners of the quadrilateral SQb, the point P1b has an NMOS threshold voltage value greater than the typical value Vtypn of the absolute value of the NMOS threshold voltage by δVthna, and a PMOS threshold voltage value greater than the typical value Vtypp of the absolute value of the PMOS threshold voltage by δVthpa. The point P3b has an NMOS threshold voltage value less than the typical value Vtypn by δVthnb, and a PMOS threshold voltage value less than the typical value Vtypp by δVthpb.

The greater the absolute value of the threshold voltage is, the lower the response speed of the NMOS and PMOS transistors is. Contrary to the points of the quadrilateral SQa, the point P1b at which both of the absolute values Vthn and Vthp of the threshold voltages are maximized corresponds to the condition BB, and the point P3b at which both are minimized corresponds to the condition AA. The point P2b corresponds to the condition AB, and the point P4b corresponds to the condition BA.

The determination of a device parameter set at each of the corner points provides the range of variations in the device parameters corresponding to the quadrilateral SQb indicating the entire area of the variations in the absolute values Vthn and Vthp of the threshold voltages.

Conventionally, a device parameter set at each corner point has been determined by a method as shown in FIG. 11. First, initial values of a device parameter set at each corner point varying depending on variations are provided to a simulator as in step S102. The initial values used herein may include recorded values of the variations specified based on past data in a manufacturing line, values of measurement obtained by new sampling, and the like.

Then, as in Step S103, desired electrical characteristic values (e.g., Idsatn+δIdsatna and Vthn+δVthna in the above instances) tolerable for each corner and information (a gate length and a gate width; and a body potential and a gate bias value) about a device of interest are provided to the simulator.

Next, using the provided initial values of the device parameter set, the simulator performs a circuit simulation based on the information about the device of interest as in Step S104 to calculate electrical characteristic values corresponding to the device parameter set.

Subsequently, as in Step S105, whether or not the electrical characteristic values satisfy the desired electrical characteristic values provided in Step S103 is verified. If they do, the device parameter set is adopted as a device parameter set at that corner as in Step S107.

If they do not, the values of sensitive device parameters are re-adjusted in accordance with the device size as in Step S106, and the circuit simulation is performed again. The operations of simulation, verification and device parameter set re-adjustment are repeated until the calculated electrical characteristic values satisfy the tolerable electrical characteristics provided in Step S103.

The expression “sensitive device parameters in accordance with the device size” refers to device parameters listed in Table 1, for example, for a MISFET. In Table 1, whether the transistor gate size is long or short is determined depending on whether or not an electrical characteristic is sensitive to a slight variation in channel length, and whether the transistor gate size is wide or narrow is determined depending on whether or not the electrical characteristic is sensitive to a slight variation in channel width.

TABLE 1

| transistor size | parameter |
|---|---|
| LONG/WIDE | Tox, Vth0 |
| SHORT/WIDE | Δ L |
| SHORT/NARROW | Δ W |

The determination of a device parameter set at the corner point P2a in the instance of FIG. 9 will be taken as an example for description. First, initial values of the device parameter set are provided to a simulation device (Step S102). A desired electrical characteristic value tolerable for the point P2a is also provided to the simulation device (Step S103).

Then, a circuit simulation is performed (Step S104). It is assumed that the electrical characteristic at a point P7a in FIG. 9 is determined. Subsequently, a judgement is made as to whether or not the electrical characteristic value at the point P7a falls within a range regarded as approximately equal to the electrical characteristic value at the point P2a (Step S105). If judged as being within the range, the electrical characteristic value at the point P7a is adopted as the electrical characteristic value at the point P2a (Step S107).

If the electrical characteristic value at the point P7a is not judged as being within the range, the re-adjustment of the sensitive parameter values and the circuit simulation are repeated until the electrical characteristic value falls within the range regarded as approximately equal to the electrical characteristic value at the point P2a (Step S106).

A similar process is performed to sequentially determine device parameter sets at the remaining corner points P1a, P3a and P4a.

Unfortunately, the above-mentioned simulation method, in which the circuit simulation calculation, verification and device parameter set re-adjustment are repeated until the desired electrical characteristic values are reached, requires much time and handling to determine the values of the device parameter set at each corner.

Moreover, which device parameter value is to be adjusted in the device parameter set and to what extent it is to be adjusted are not clear. Therefore, the above-mentioned simulation method is required to gradually re-adjust the device parameter set by trial and error, presenting difficulties in determining all of the adjusted values of the device parameters at once (or uniquely).

### SUMMARY OF THE INVENTION

A first aspect of the present invention is intended for a method of simulation, wherein variations in an electrical characteristic of a device constituting a semiconductor integrated circuit are represented in the form of a corner model including at least one corner defining a limit of the variations. According to the present invention, the method comprises the steps of: (a) preparing a predetermined value tolerable for the variations in the electrical characteristic at the at least one corner; (b) performing a circuit simulation to determine a device parameter sensitivity which is the derivative of the electrical characteristic with respect to a device parameter indicative of information about the device; and (c) applying the device parameter sensitivity and the predetermined value of the electrical characteristic to the normal equation of the least squares method to determine variations in the device parameter at the at least one corner.

Preferably, according to a second aspect of the present invention, the method of the first aspect further comprises the step of (d) calculating the variations in the electrical characteristic at the at least one corner, based on the multiplication of the device parameter sensitivity provided in the step (b) and the variations in the device parameter at the at least one corner provided in the step (c).

Preferably, according to a third aspect of the present invention, in the method of the second aspect, a comparison is made between the variations in the electrical characteristic at the at least one corner calculated in the step (d) and the predetermined value prepared in the step (a), and, if an error of the electrical characteristic is greater than another predetermined value, the steps (b) through (d) are executed again.

Preferably, according to a fourth aspect of the present invention, in the method of the second aspect, a comparison is made between the variations in the electrical characteristic at the at least one corner calculated in the step (d) and the predetermined value prepared in the step (a), and, if an error of the electrical characteristic is greater than another predetermined value, a new device parameter is introduced to execute the steps (b) through (d) using the new device parameter and the device parameter in combination.

Preferably, according to a fifth aspect of the present invention, in the method of the first aspect, the device parameter includes a plurality of device parameters; and the step (c) is not executed upon at least one of the device parameters, but is executed upon only the remainder of the device parameters.

Preferably, according to a sixth aspect of the present invention, in the method of the first aspect, the variations in the device parameter are determined using the weighted least squares method in the step (c).

A seventh aspect of the present invention is intended for a device for simulation, the device using a method of simulation as recited in any one of the first to sixth aspects to represent the variations in the electrical characteristic of the device in the form of the corner model. According to the present invention, the device comprises: data input means for inputting the predetermined value tolerable for the variations in the electrical characteristic; data output means; a simulator for simulating the amount of change in the electrical characteristic as would occur when the device parameter is changed, to determine the device parameter sensitivity; and data processing means for applying the device parameter sensitivity determined by the simulator and the predetermined value of the electrical characteristic inputted to the data input means to the normal equation of the least squares method, to determine variations in the device parameter at the at least one corner, thereby outputting the variations in the device parameter at the at least one corner to the data output means.

In accordance with the first aspect of the present invention, the variations in the device parameter at the at least one corner are determined by applying the device parameter sensitivity and the predetermined value of the electrical characteristic to the normal equation of the least squares method. Therefore, the method can determine the variations in the device parameter tolerable for the at least one corner without the need to repeat the circuit simulation and also can uniquely determine the variations in the device parameter.

In accordance with the second aspect of the present invention, the variations in the electrical characteristic at the at least one corner are calculated based on the multiplication of the device parameter sensitivity and the variations in the device parameter at the at least one corner. Therefore, the method can verify whether or not the value of the variations in the electrical characteristic calculated in the step (d) is regarded as approximately equal to the predetermined value prepared in the step (a).

In accordance with the third aspect of the present invention, the comparison is made between the variations in the electrical characteristic at the at least one corner calculated in the step (d) and the predetermined value prepared in the step (a), and, if the error of the electrical characteristic is greater than another predetermined value, the steps (b) through (d) are executed again. Therefore, the method might determine the device parameter and the electrical characteristic at the at least one corner with high accuracy.

In accordance with the fourth aspect of the present invention, the new device parameter is introduced, and the steps (b) through (d) are executed using the new device parameter and the device parameter in combination. This further increases the accuracy of the electrical characteristic provided in the step (d).

In accordance with the fifth aspect of the present invention, the step (c) is not executed upon at least one of the device parameters but is executed upon only the remainder of the device parameters. Therefore, the method can determine the variations in the device parameter tolerable for the at least one corner while reducing the amount of calculation.

In accordance with the sixth aspect of the present invention, the weighted least squares method is used to determine the variations in the device parameter in the step (c). Therefore, the method can determine the variations in the device parameter more correctly while emphasizing the error of the electrical characteristic to which particular importance is desired to be attached.

In accordance with the seventh aspect of the present invention, there is provided a device for simulation which implements the method of simulation as set forth in any one of the first to sixth aspects of the present invention.

It is therefore an object of the present invention to provide a method of and device for simulation which can determine the values of a device parameter set at each corner without repeating a circuit simulation and which can uniquely determine the values of the device parameter set.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart showing a method of simulation according to a first preferred embodiment of the present invention;

FIG. 2 is a flowchart showing the method of simulation according to a second preferred embodiment of the present invention;

FIG. 3 is a flowchart showing the method of simulation according to a third preferred embodiment of the present invention;

FIG. 4 shows a simulation device according to a fourth preferred embodiment of the present invention;

FIGS. 5 and 6 are flowcharts showing the method of simulation according to the fourth preferred embodiment;

FIG. 7 is a cross-sectional view of a MISFET structure;

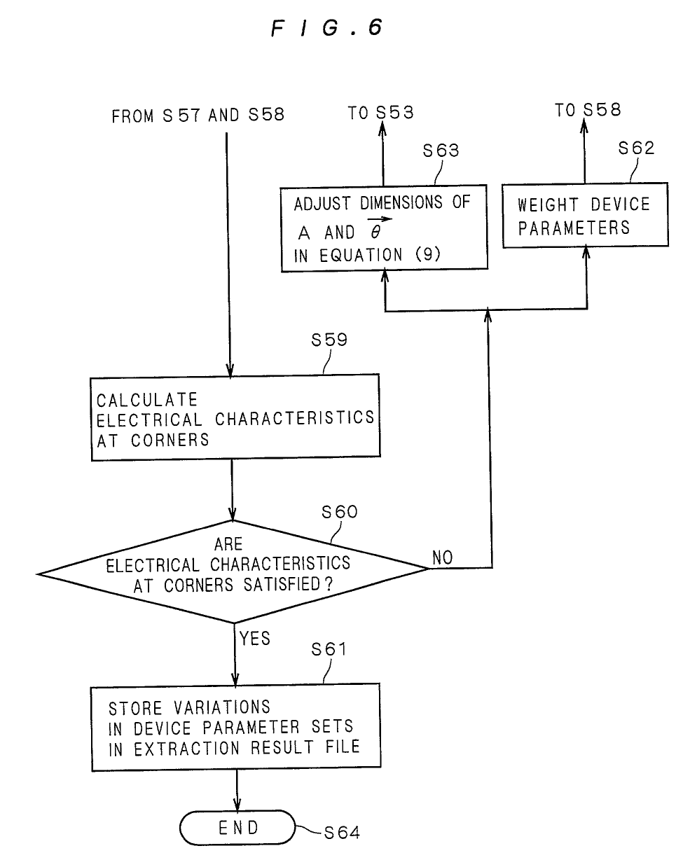

FIG. 8 is a top plan view of the MISFET structure;

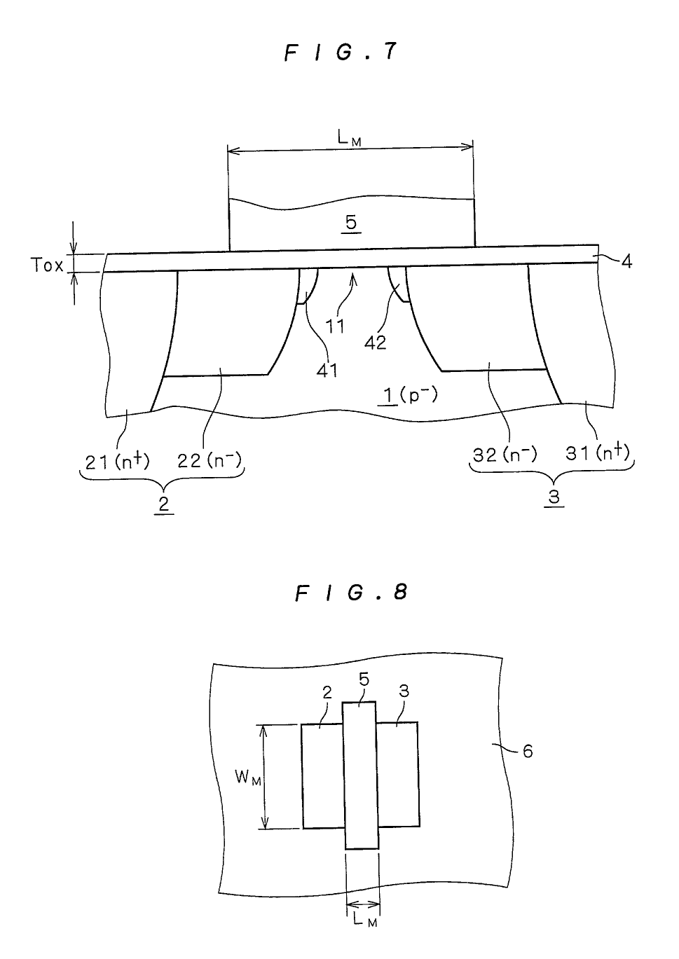

FIGS. 9 and 10 illustrate corner models; and

FIG. 11 is a flowchart showing a background art method of simulation.

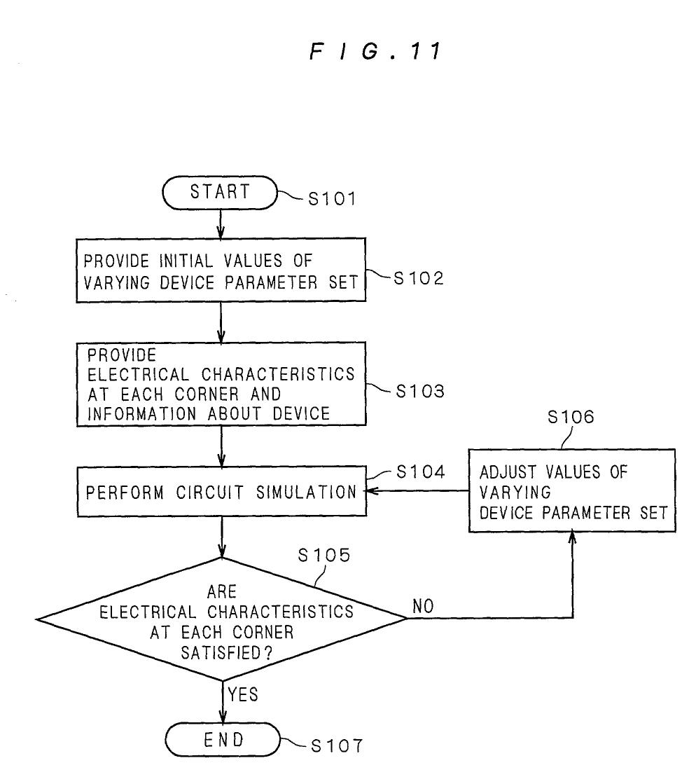

### DESCRIPTION OF THE PREFERRED EMBODIMENTS

<First Preferred Embodiment>

A first preferred embodiment of the present invention is intended for providing a method of simulation which can determine the values of a device parameter set at each corner without repeating a circuit simulation and which can uniquely determine the values of the device parameter set. To provide the method, the present invention uses the linear least squares method.

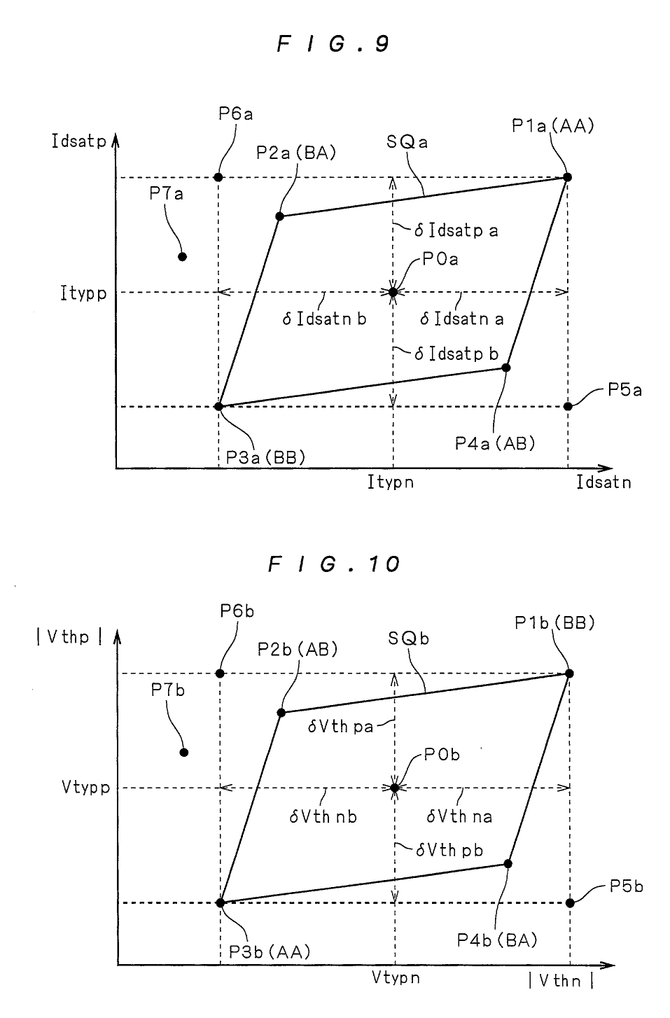

The first preferred embodiment will now be described based on the corner models for a CMOS inverter shown in FIGS. 9 and 10 as an example, as described in the background art. It is assumed that m CMOS inverters are present in the first preferred embodiment. As in the background art, examples of the model parameters used herein include a channel length difference ΔL between the geometric gate length and the effective channel length of NMOS and PMOS transistors constituting the CMOS inverters, a channel width difference ΔW between the geometric gate width and the effective channel width of the transistors, and a gate insulation film thickness Tox. An example of the process parameters used herein includes a threshold voltage Vth0 at the time that a body voltage is 0 V. The threshold voltage Vth0 at the time the body voltage is 0 V may be, for example, that of a transistor having a gate size which is “LONG/WIDE.” Examples of the electrical characteristics of the devices used herein include a saturation current value Idsat in a constant current region and a threshold voltage value Vth.

In regions (the region indicated by the quadrilateral SQa of FIG. 9 and the region indicated by the quadrilateral SQb of FIG. 10) wherein corner models are to be produced, variations in electrical characteristics may be regarded as linear with variations in device parameter set. The variations in electrical characteristics near the points P0a and P0b and the corresponding variations in device parameter set are slight enough to be regarded as changing linearly.

The relationships between the variations in electrical characteristics and the variations in device parameter set for the NMOS and PMOS transistors are expressed by Equations (1) through (4) in which data about the electrical characteristics to be observed by simulation is on the left-hand side and terms of device parameters responsible for changes in the electrical characteristics are on the right-hand side.

$$\begin{matrix}Itypn + δ Idsatn = Itypn + δ ( Δ Ln ) \frac{\partial Idsatn}{\partial Δ Ln} + δ ( Δ Wn ) \frac{\partial Idsatn}{\partial Δ Wn} + δ Toxn \frac{\partial Idsatn}{\partial Toxn} + δ Vth0n \frac{\partial Idsatn}{\partial Vth0n} + f1n & ( 1 ) \\ Vtypn + δ Vthn = Vtypn + δ ( Δ Ln ) \frac{\partial Vthn}{\partial Δ Ln} + δ ( Δ Wn ) \frac{\partial Vthn}{\partial Δ Wn} + δ Toxn \frac{\partial Vthn}{\partial Toxn} + δ Vth0n \frac{\partial Vthn}{\partial Vth0n} + f2n & ( 2 ) \\ Itypp + δ Idsatp = Itypp + δ ( Δ Lp ) \frac{\partial Idsatp}{\partial Δ Lp} + δ ( Δ Wp ) \frac{\partial Idsatp}{\partial Δ Wp} + δ Toxp \frac{\partial Idsatp}{\partial Toxp} + δ Vth0p \frac{\partial Idsatp}{\partial Vth0p} + f1p & ( 3 ) \\ Vtypp + δ Vthp = Vtypp + δ ( Δ Lp ) \frac{\partial Vthp}{\partial Δ Lp} + δ ( Δ Wp ) \frac{\partial Vthp}{\partial Δ Wp} + δ Toxp \frac{\partial Vthp}{\partial Toxp} + δ Vth0p \frac{\partial Vthp}{\partial Vth0p} + f2p & ( 4 )\end{matrix}$$

where Itypn is a typical value of an NMOS saturation current value at the point P0a, Itypp is a typical value of a PMOS saturation current value at the point P0a, Vtypn is a typical value of an NMOS threshold voltage at the point P0b, and Vtypp is a typical value of a PMOS threshold voltage at the point P0b.

In Equation (1), δIdsatn, like δIdsatna and δIdsatnb shown in FIG. 9, is a variation from the typical value Itypn; δ(ΔLn) is a variation from a channel length difference ΔLn in the device parameter set corresponding to the NMOS electrical characteristics at the point P0a; and δ(ΔWn), δToxn and δVth0n are variations defined in a like manner. Also, ∂Idsatn/∂ΔLn, ∂Idsatn/∂ΔWn, ∂Idsatn/∂ΔToxn and ∂Idsatn/∂ΔVth0n which are the derivatives of the electrical characteristics with respect to the device parameters are device parameter sensitivities of the NMOS saturation current value to the device parameters, respectively.

Likewise, the terms in Equations (2) through (4) denote variations in the saturation current value and the threshold voltage from their typical values for the NMOS and PMOS transistors, variations in device parameters corresponding to the typical values, and the device parameter sensitivities of the saturation current value and the threshold voltage to the device parameters. The terms f1n, f2n, f1p, f2p on the right-hand side of Equations (1) through (4) are terms other than those regarding the device parameters and denoting errors such as calculation errors during simulation.

A vector x, a vector θ, a matrix A and a vector f are defined as

$$\begin{matrix} \vec{x} = ( \begin{matrix}δ Idsatn1 \\ ⋮ \\ δ Idsatnm \\ δ Vthn1 \\ ⋮ \\ δ Vthnm \\ δ Idsatp1 \\ ⋮ \\ δ Idsatpm \\ δ Vthp1 \\ ⋮ \\ δ Vthpm\end{matrix} ) & ( 5 ) \\ \vec{θ} = ( \begin{matrix}δ ( Δ Ln ) \\ δ ( Δ Wn ) \\ δ Toxn \\ δ Vth0n \\ δ ( Δ Lp ) \\ δ ( Δ Wp ) \\ δ Toxp \\ δ Vth0p\end{matrix} ) & ( 6 ) \\ A = ( \begin{matrix}\frac{\partial Idsatn1}{\partial Δ Ln} & \frac{\partial Idsatn1}{\partial Δ Wn} & & \frac{\partial Idsatn1}{\partial Toxn} & \frac{\partial Idsatn1}{\partial Vth0n} & 0 & 0 & & 0 & 0 \\ & & ⋮ & & & & & ⋮ & & \\ \frac{\partial Vthn1}{\partial Δ Ln} & \frac{\partial Vthn1}{\partial Δ Wn} & & \frac{\partial Vthn1}{\partial Toxn} & \frac{\partial Vthn1}{\partial Vth0n} & 0 & 0 & & 0 & 0 \\ & & ⋮ & & & & & ⋮ & & \\ 0 & 0 & & 0 & 0 & \frac{\partial Idsatp1}{\partial Δ Lp} & \frac{\partial Idsatp1}{\partial Δ Wp} & & \frac{\partial Idsatp1}{\partial Toxp} & \frac{\partial Idsatp1}{\partial Vth0p} \\ & & ⋮ & & & & & ⋮ & & \\ 0 & 0 & & 0 & 0 & \frac{\partial Vthp1}{\partial Δ Lp} & \frac{\partial Vthp1}{\partial Δ Wp} & & \frac{\partial Vthp1}{\partial Toxp} & \frac{\partial Vthp1}{\partial Vth0p} \\ & & ⋮ & & & & & ⋮ & & \end{matrix} ) & ( 7 )\end{matrix}$$

$$\vec{f} = ( \begin{matrix}f1n1 \\ ⋮ \\ f1nm \\ f2n1 \\ ⋮ \\ f2nm \\ f1p1 \\ ⋮ \\ f1pm \\ f2p1 \\ ⋮ \\ f2pm\end{matrix} ) \qquad ( 8 )$$

Then, Equations (1) through (4) are expressed together as

\vec{x}=A\vec{θ}+\vec{f} (9)

wherein Itypn, Vtypn, Itypp and Vtypp which are present on both sides are eliminated. Because of the presence of m CMOS inverters, m equations are formulated for each of Equations (1) through (4). This is indicated by the adscripts 1 to m added to Idsatn, Vthn, f1n, f2n and the like in the vector x, the matrix A and the vector f.

According to the linear least squares method, an observed value error is minimized when the square of the norm of the vector f of an error has the least value. Therefore, it is required to determine the inflection point of the value of the square of the norm of

$$\begin{matrix}{\vert \vec{f} \vert}^{2} = {\sum }_{i = 1}^{N} {( yspeci - ysimi )}^{2} \\ = {\sum }_{i = 1}^{N} {( δ yspeci - δ ysimi )}^{2} \\ = {}^{t} ( \vec{x} - A \vec{θ} ) ( \vec{x} - A \vec{θ} )\end{matrix} \qquad ( 10 )$$

where yspeci in the first expression on the right-hand side is an electrical characteristic value at a corner point tolerable for variations, ysimi is an electrical characteristic value at a corner point observed by simulation, and i=1 to N (N=4 herein). For example, yspec1 is obtained by subtracting f1n and Itypn from the right-hand side of Equation (1); yspec2 is obtained by subtracting f2n and Vtypn from the right-hand side of Equation (2); yspec3 is obtained by subtracting f1p and Itypp from the right-hand side of Equation (3); yspec4 is obtained by subtracting f2p and Vtypp from the right-hand side of Equation (4); ysim1 is obtained by subtracting Itypn from the left-hand side of Equation (1); ysim2 is obtained by subtracting Vtypn from the left-hand side of Equation (2); ysim3 is obtained by subtracting Itypp from the left-hand side of Equation (3); and ysim4 is obtained by subtracting Vtypp from the left-hand side of Equation (4).

In Equation (10), δyspeci in the second expression on the right-hand side corresponds to components of the product of the matrix A and the vector θ in the first term on the right-hand side of Equation (9); δysimi corresponds to components of the vector x on the left-hand side of Equation (9); and ^{t}(x−Aθ) in the third expression on the right-hand side is the transpose of the vector (x−Aθ).

The inflection point of the value of the square of the norm of Equation (10) is determined by solving

$$\frac{\partial {\vert \vec{f} \vert}^{2}}{\partial \vec{θ}} = 0 \qquad ( 11 )$$

The partial differentiation with respect to the vector θ in Equation (11) means the differentiation with respect to each of the components of the vector θ. Since the vector θ used herein has eight components, Equation (11) means substantially eight simultaneous equations.

Using the third expression on the right-hand side of Equation (10), Equation (11) is solved, with the matrix representation maintained.

^{t}AA\vec{θ}=^{t}A\vec{x} (12)

Equation (12) is referred to as the normal equation of the least squares method. In Equation (12), ^{t}A is the transpose of the matrix A.

If ^{t}AA on the left-hand side of Equation (12) is regular, the least squares estimate is given by

\vec{θe}=(^{t}AA)^{-1 t}A\vec{x} (13)

where the vector θe has components which are the estimates of the respective components of the vector θ.

Thus, determining the device parameter sensitivities which are the components of the matrix A and calculating the vector θe at each corner point using Equation (13) provide a device parameter set corresponding to the electrical characteristics required for each corner point.

The device parameter sensitivities are determined by performing a circuit simulation. More specifically, the device parameter sensitivities are determined by observing the amount of slight change in electrical characteristics from the electrical characteristics at the points P0a and P0b which are provided when the components of the device parameter set are slightly changed one by one.

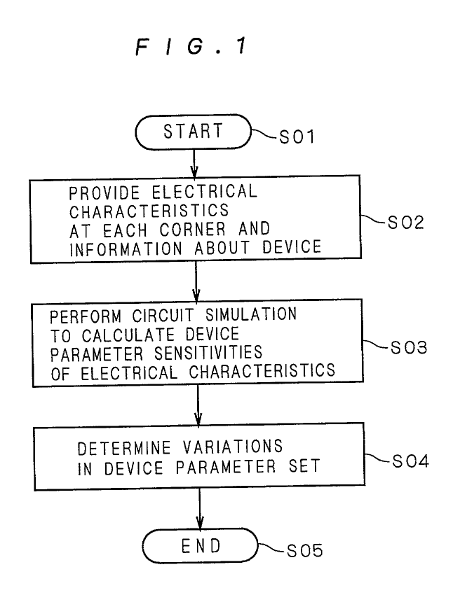

The above-mentioned procedure will be described with reference to FIG. 1. FIG. 1 is a flowchart showing the method of simulation according to the first preferred embodiment of the present invention.

First, values (Itypn+δIdsatna, Itypn−δIdsatnb and the like) tolerable for variations in electrical characteristics at each corner and information (the typical values of the model and process parameters corresponding to the points P0a and P0b) about a device of interest are prepared (Step S02). Then, a circuit simulation is performed to determine the device parameter sensitivities of the electrical characteristics to the device parameters (Step S03).

Equation (13) derived from the normal equation of the least squares method is used to calculate variations (δ(ΔL), δ(ΔW), δTox, δVth0) in device parameter set at each corner from the device parameter sensitivities provided in Step S03 and the electrical characteristic values provided in Step S02 (Step S04).

The simulation method according to the first preferred embodiment determines the variations in device parameter set at each corner by applying the device parameter sensitivities and the electrical characteristic values to the normal equation of the least squares method, to require the circuit simulation to be performed only when determining the device parameter sensitivities. This eliminates the need to repeat the circuit simulation to determine the variations in the device parameters tolerable for the corners. Additionally, Equation (11) which means a system of simultaneous equations the number of which equals the number of device parameters is uniquely solved based on a fundamental theorem of algebra. Therefore, the simulation method of the first preferred embodiment can uniquely determine the variations in the device parameters.

<Second Preferred Embodiment>

A method of simulation according to a second preferred embodiment of the present invention is a modification of the method of simulation according to the first preferred embodiment. In the method according to the second preferred embodiment, the values of variations in device parameter set at each corner which are determined in the first preferred embodiment are used to actually calculate the electrical characteristics at each corner and to verify whether or not the calculated electrical characteristics are regarded as approximately equal to the established values tolerable for electrical characteristic variations.

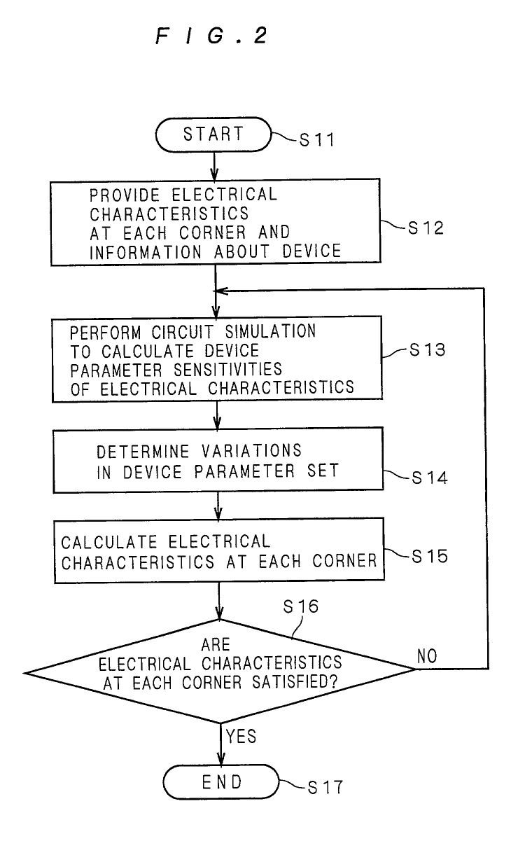

FIG. 2 is a flowchart showing the method of simulation according to the second preferred embodiment. First, as in the first preferred embodiment, the values tolerable for variations in electrical characteristics at each corner and information about a device of interest are prepared (Step S12).

Then, a circuit simulation is performed to determine the device parameter sensitivities of the electrical characteristics to the device parameters (Step S13). Equation (13) derived from the normal equation of the least squares method is used to calculate variations in device parameter set at each corner from the device parameter sensitivities provided in Step S13 and the electrical characteristic values provided in Step S12 (Step S14).

Thereafter, the electrical characteristic values at each corner are calculated based on the variations in device parameter set provided in Step S14 (Step S15). Equation (9) from which the vector f is eliminated should be used for the calculation of the electrical characteristic values. In other words, the variations in electrical characteristics should be calculated based on the multiplication of the device parameter sensitivities and the device parameter set.

Then, whether or not the electrical characteristic values provided in Step S15 satisfy the established values tolerable for electrical characteristic variations is verified (Step S16). This verification may be performed, for example, using the value of an error ERR determined by

$${ERR}_{XX}^{2} = \frac{{( ysimin - yspecin )}^{2} + {( ysimip - yspecip )}^{2}}{{yspecin}^{2} + {yspecip}^{2}} \qquad ( 14 )$$

ERR=\sqrt{¼}(ERR_{FF}²+ERR_{SS}²+ERR_{FS}²+ERR_{SF}²) (15)

where ERR_{XX}² is the square error of the electrical characteristics at each corner (XX is a subscript indicative of NMOS and PMOS response speeds, respectively; F indicates the fastest response speed and S indicates the slowest response speed), and ysimin, ysimip, yspecin, yspecip are the values of ysimi and yspeci in the first expression on the right-hand side of Equation (10) for NMOS and PMOS transistors.

If the value of the error ERR is greater than a predetermined value, there is a possibility that, for example, the calculation of the device parameter sensitivities has an error. Then, the flow should be returned to Step S13 wherein the device parameter sensitivities are calculated again. This might reduce the error of the device parameter sensitivities to make the value of the error ERR less than the predetermined value, in which case the device parameter set and the electrical characteristics with high accuracy are provided.

The simulation method according to the second preferred embodiment calculates the variations in the electrical characteristics at each corner based on the multiplication of the device parameter sensitivities and the variations in device parameters at each corner, to verify whether or not the calculated electrical characteristics are regarded as approximately equal to the established values tolerable for electrical characteristic variations.

Additionally, the flow returns to Step S13 to calculate the device parameter sensitivities again if the value of the error ERR is greater than the predetermined value. This might make the value of the error ERR less than the predetermined value to provide the device parameter set and the electrical characteristics with high accuracy.

<Third Preferred Embodiment>

A method of simulation according to a third preferred embodiment of the present invention is a modification of the method of simulation according to the second preferred embodiment. The third preferred embodiment differs from the second preferred embodiment in the step which follows the step of verifying whether or not the calculated electrical characteristics at each corner are regarded as approximately equal to the established values tolerable for the electrical characteristic variations. If the calculated electrical characteristics are not regarded as approximately equal to the established values, the dimensions of the matrix A and the vector θ in Equation (9) are adjusted or the device parameters are weighted.

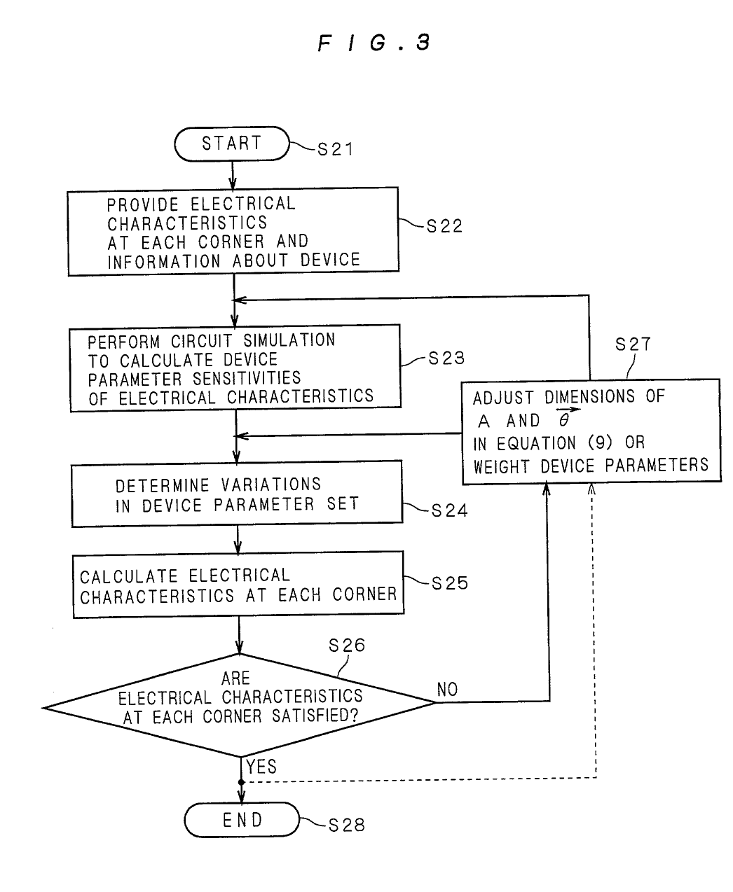

FIG. 3 is a flowchart showing the method of simulation according to the third preferred embodiment. First, as in the second preferred embodiment, the values tolerable for variations in electrical characteristics at each corner and information about a device of interest are prepared (Step S22).

Then, a circuit simulation is performed to determine the device parameter sensitivities of the electrical characteristics to the device parameters (Step S23). Equation (13) derived from the normal equation of the least squares method is used to calculate variations in device parameter set at each corner from the device parameter sensitivities provided in Step S23 and the electrical characteristic values provided in Step S22 (Step S24).

Thereafter, the electrical characteristic values at each corner are calculated based on the variations in device parameter set provided in Step S24 (Step S25). Then, whether or not the electrical characteristic values provided in Step S25 satisfy the established values tolerable for electrical characteristic variations is verified (Step S26). This verification may be performed, for example, using the value of the error ERR, as in the second preferred embodiment.

If the value of the error ERR is greater than a predetermined value, the dimensions of the matrix A and the vector θ in Equation (9) are adjusted or the device parameters are weighted.

The expression “adjusting the dimensions of the matrix A and the vector θ in Equation (9)” refers to adding a new device parameter which influences the electrical characteristic values to increase the dimension of the matrix A and the vector θ. In this case, the addition of the new device parameter involves the need to newly calculate the device parameter sensitivities of the electrical characteristics to the new device parameter in Step S23 (which is indicated by the arrow directed from Step S27 to Step S23 in FIG. 3).

That is, the new device parameter is introduced, and the calculation of the device parameter sensitivities and the application of the least squares method are carried out upon the new device parameter. This increases the accuracy of the electrical characteristics provided in Step S25.

The expression “weighting the device parameters” refers to modifying Equation (13) into

\vec{θe}=(^{t}AWA)^{-1 t}AW\vec{x} (16)

where W is a weighting matrix defined by

$$W = ( \begin{matrix}W1 & 0 & 0 & & 0 \\ 0 & W2 & 0 & ⋯ & 0 \\ 0 & 0 & W3 & & 0 \\ & ⋮ & & ⋰ & \\ 0 & 0 & 0 & & Wn\end{matrix} ) \qquad ( 17 )$$

The weighting matrix W is a diagonal matrix having diagonal components W1 to Wn to be assigned as weights to the components of the vector x and the components in the respective rows of the matrix A. This process corresponds to multiplying a weight by δyspeci and δysimi in the second expression on the right-hand side of Equation (10) for each electrical characteristic, and also means changing the degree of contribution of each electrical characteristic to the norm of the vector f. Such a technique is known as a weighted least squares method which can determine the device parameter set more correctly while emphasizing the error of the component of an electrical characteristic to which particular importance is desired to be attached among the components of the vector x.

Although the weighting process is performed in Step S27 after the step of verification in Step S26 in the third preferred embodiment, the device parameters may be weighted in Step S24 when the device parameter set is calculated. Alternatively, even if the calculated electrical characteristics at each corner are regarded as approximately equal to the established values tolerable for the electrical characteristic variations in Step S26, the device parameters may be weighted and then Step S24 may be executed (which is indicated by the broken arrow directed from the arrow with YES in Step S26 to Step S27).

Further, even if the calculated electrical characteristics at each corner are regarded as approximately equal to the established values tolerable for the electrical characteristic variations in Step S26, an adjustment may be made such that a device parameter of a low parameter sensitivity, for example, is eliminated from the matrix A and the vector θ in Equation (9) in Step S27 to decrease the dimensions of the matrix A and the vector θ (e.g., the component δToxn in the vector θ is removed and the components in the third column of the matrix A are removed), and only the device parameters of a high device parameter sensitivity are used to calculate the device parameter set again (which is also indicated by the broken arrow directed from the arrow with YES in Step S26 to Step S27). In other words, without applying one or some of the device parameters to the least squares method, Step S24 is performed again only on the remaining device parameters. This reduces the amount of calculation to rapidly calculate the device parameter set and the electrical characteristics again in Steps S24 and S25 while placing stress on the device parameters of a high device parameter sensitivity.

The simulation method according to the third preferred embodiment adjusts the dimensions of the matrix A and the vector θ in Equation (9) to further increase the accuracy of the electrical characteristics. Otherwise, the method can reduce the amount of calculation to rapidly calculate the device parameter set in Step S24 while placing stress upon the device parameters of a high device parameter sensitivity. Additionally, when the weighted least squares method is used, the method of the third preferred embodiment can determine the device parameter set more correctly while emphasizing the error of an electrical characteristic to which particular importance is desired to be attached.

<Fourth Preferred Embodiment>

A fourth preferred embodiment of the present invention presents a simulation device which implements the method of simulation, for example, according to the third preferred embodiment.

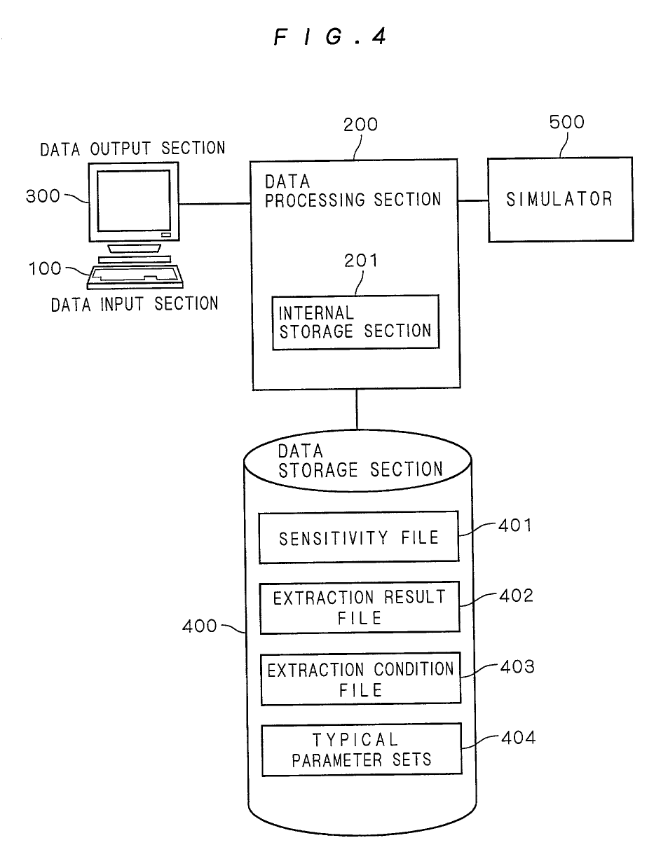

FIG. 4 shows a construction of the simulation device according to the fourth preferred embodiment. The simulation device comprises a data input section 100 for inputting numerical data and the like, a data processing section 200 for calculation and transfer of various data and the like, a data output section 300 for displaying the results of calculation of the device parameter set and the electrical characteristics and other data, a data storage section 400 for storing various data therein, and a simulator 500 for performing a circuit simulation.

The data processing section 200 includes, for example, a CPU (Central Processing Unit), and comprises an internal storage section 201 such as a cache memory. The data storage section 400 is an external storage device, such as a hard disk, which stores therein a sensitivity file 401 in which the device parameter sensitivities calculated in the past are recorded, an extraction result file 402 in which the device parameter sets calculated in the past are recorded, an extracted condition file 403 in which extraction conditions (MISFET gate bias value, body voltage value and the like) used in calculation of the device parameter sets are recorded, and a file 404 in which typical parameter sets which are sets of device parameters having typical values at the respective points P0a, P0b and the like are recorded.

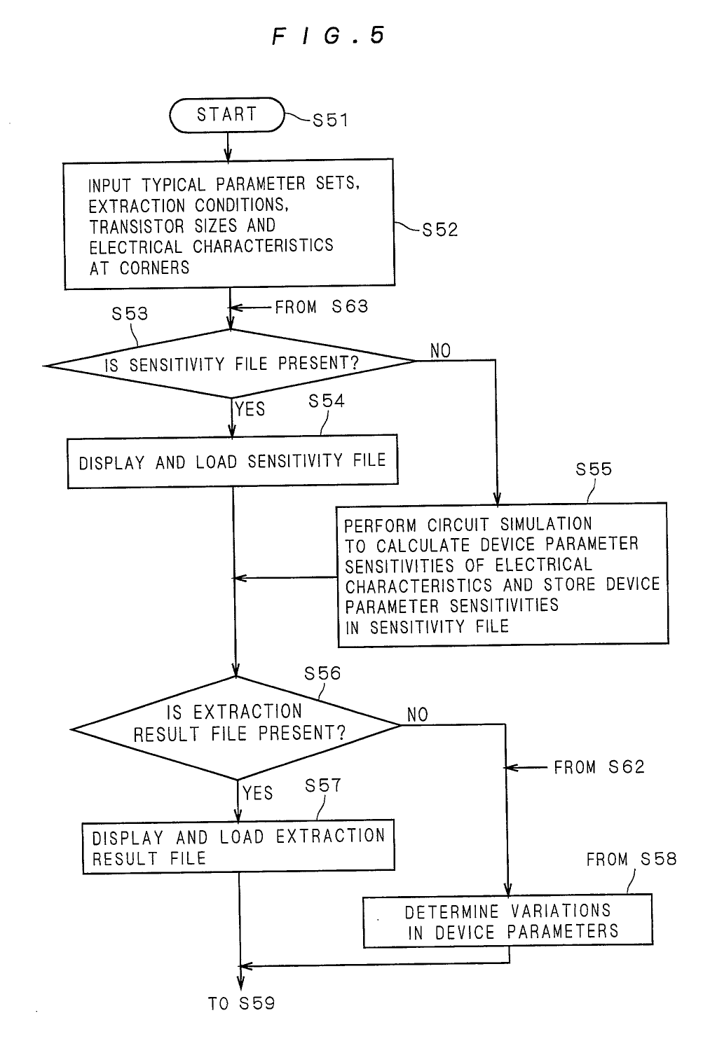

FIGS. 5 and 6 are flowcharts in greater detail when the flowchart of FIG. 3 is applied to the simulation device of the fourth preferred embodiment.

First, in Step S52, the typical parameter sets, the extraction conditions, transistor sizes such as the gate length and the gate width, and the values tolerable for the variations in electrical characteristics at the corners are inputted through the data input section 100. The input data for use in calculation of the device parameter sets and the electrical characteristics are recorded in the internal storage section 201 or the data storage section 400 by the data processing section 200.

Next, the data processing section 200 examines whether device parameter sensitivities have been calculated in the past under the same conditions as the input data with reference to the various files 401 to 404 in the data storage section 400 (Step S53). If the calculation has been made in the past, the record thereof is loaded from the sensitivity file 401 and displayed (Step S54). The data processing section 200 uses the recorded contents to calculate the device parameter sets and the electrical characteristics.

If no device parameter sensitivities have been calculated under the same conditions in the past, the data processing section 200 provides the input data to the simulator 500. Then, the simulator 500 performs a circuit simulation to calculate the device parameter sensitivities of the electrical characteristics (Step S55). The result of calculation is transferred to the data processing section 200. The data processing section 200 stores the result of calculation in the sensitivity file 401 while displaying the result of calculation on the data output section 300.

Next, the data processing section 200 examines whether or not device parameter sets have been calculated in the past under the same conditions as the above-mentioned input data by using the device parameter sensitivities provided in Step S54 or S55 with reference to the various files 401 to 404 in the data storage section 400 (Step S56). If the calculation has been made in the past, the record thereof is loaded from the extraction result file 402 and displayed (Step S57). The data processing section 200 uses the recorded contents to calculate the electrical characteristics.

If no device parameter sets have been calculated under the same conditions in the past, the data processing section 200 calculates the device parameter sets using Equation (13) (Step S58). The data processing section 200 displays the result of calculation on the data output section 300.

Next, the data processing section 200 applies the device parameter sensitivities and the device parameter sets to Equation (9) from which the vector f is eliminated, to calculate the electrical characteristics at the respective corners (Step S59). Then, the data processing section 200 verifies whether or not the result of calculation satisfies the values tolerable for the variations in the electrical characteristics inputted in Step S52 (Step S60).

If the result does not satisfy the tolerable values as a result of the verification, the dimensions of the matrix A and the vector θ in Equation (9) are adjusted (Step S63) or the device parameters are weighted (Step S62). After the adjustment of the dimensions in Step S63, the flow returns to Step S53 for calculation of new device parameter sensitivities. After the weighting of the device parameters in Step S62, the flow returns to Step S58 for calculation of new device parameter sets.

The flow indicated by the broken arrow directed from Step S26 to Step S27 in FIG. 3 is not shown in FIGS. 5 and 6 for the purposes of avoiding complication. It is, however, needless to say that such a flow is provided.

If the result of calculation satisfies the tolerable values as a result of the verification, the calculated device parameter sets are stored in the extraction result file 402 (Step S61). Then, the simulation is completed (Step S64).

The fourth preferred embodiment has been described using the implementation of the simulation method according to the third preferred embodiment as an example. To implement the simulation method according to the second preferred embodiment, Steps S62 and S63 in FIG. 6 are omitted, and the flow indicated by the arrow with NO in Step S60 is returned to Step S53. To implement the simulation method according to the first preferred embodiment, Steps S59, S60, S62 and S63 in FIG. 6 are omitted, and Step S61 is executed after Steps S57 and S58.

While the invention has been described in detail, the foregoing description is in all aspects illustrative and not restrictive. It is understood that numerous other modifications and variations can be devised without departing from the scope of the invention.

What is claimed is:

1. A method of simulation, wherein variations in an electrical characteristic of a device constituting a semiconductor integrated circuit are represented in the form of a corner model including at least one corner defining a limit of the variations, said method comprising the steps of:
(a) preparing a predetermined value tolerable for the variations in said electrical characteristic at said at least one corner;
(b) performing a circuit simulation to determine a device parameter sensitivity which is the derivative of said electrical characteristic with respect to a device parameter indicative of information about said device; and
(c) applying said device parameter sensitivity and said predetermined value of said electrical characteristic to the normal equation of the least squares method to determine variations in said device parameter at said at least one corner.

2. The method according to claim 1,
wherein said device parameter includes at least one of a model parameter regarding the shape of said device and a process parameter regarding a condition during the steps of manufacturing said semiconductor integrated circuit.

3. The method according to claim 1, further comprising the step of
(d) calculating the variations in said electrical characteristic at said at least one corner, based on the multiplication of said device parameter sensitivity provided in said step (b) and the variations in said device parameter at said at least one corner provided in said step (c).

4. The method according to claim 3,
wherein a comparison is made between the variations in said electrical characteristic at said at least one corner calculated in said step (d) and said predetermined value prepared in said step (a), and, if an error of said electrical characteristic is greater than another predetermined value, said steps (b) through (d) are executed again.

5. The method according to claim 3,
wherein a comparison is made between the variations in said electrical characteristic at said at least one corner calculated in said step (d) and said predetermined value prepared in said step (a), and, if an error of said electrical characteristic is greater than another predetermined value, a new device parameter is introduced to execute said steps (b) through (d) using said new device parameter and said device parameter in combination.

6. The method according to claim 1,
wherein said device parameter includes a plurality of device parameters, and
wherein said step (c) is not executed upon at least one of said device parameters, but is executed upon only the remainder of said device parameters.

7. The method according to claim 1,
wherein said variations in said device parameter are determined using the weighted least squares method in said step (c).

8. A device for simulation, said device using a method of simulation as recited in claim 1 to represent the variations in said electrical characteristic of said device in the form of said corner model, said device comprising:
data input means for inputting said predetermined value tolerable for the variations in said electrical characteristic;
data output means;
a simulator for simulating the amount of change in said electrical characteristic as would occur when said device parameter is changed, to determine said device parameter sensitivity; and
data processing means for applying said device parameter sensitivity determined by said simulator and said predetermined value of said electrical characteristic inputted to said data input means to the normal equation of the least squares method, to determine variations in said device parameter at said at least one corner, thereby outputting the variations in said device parameter at said at least one corner to said data output means.

9. The device according to claim 8, further comprising
a data storage section for storing therein data about said device parameter sensitivity and data about the variations in said device parameter.
